(19) United States
(12) Patent Application Publication
(10) Pub. No.: US 2021/0359536 A1
(43) Pub. Date: Nov. 18, 2021

(54) BATTERY CHARGER

(71) Applicant: HHeLi, LLC, Tulsa, OK (US)

(72) Inventor: Paige L. Johnson, Tulsa, OK (US)

(21) Appl. No.: 17/320,725

(22) Filed: May 14, 2021

Related U.S. Application Data
(60) Provisional application No. 63/025,601, filed on May 15, 2020.

(51) Int. Cl. H02J 7/00; H01M 10/44

(52) U.S. Cl. CPC H02J 7/007182; H01M 10/44

(57) ABSTRACT

A method of charging a battery cell includes applying a constant current to the battery cell until a predetermined voltage is reached on the battery cell, and then applying a constant voltage to the battery cell.

### FIELD OF THE INVENTION

This disclosure relates to electrochemical devices in general and, more particularly, to a system and method for charging battery cells.

### BRIEF DESCRIPTION OF THE DRAWINGS

FIG. 1 is a simplified cutaway view of an example lithium ion battery cell.

FIG. 2 is a simplified schematic of a battery charging circuit.

FIG. 3 is a graph of a baseline charge/discharge cycle of a lithium ion battery cell illustrating voltage and current over time.

FIG. 4 is a graph of a discharge and fast charge cycle of a lithium ion battery cell illustrating voltage and current over time.

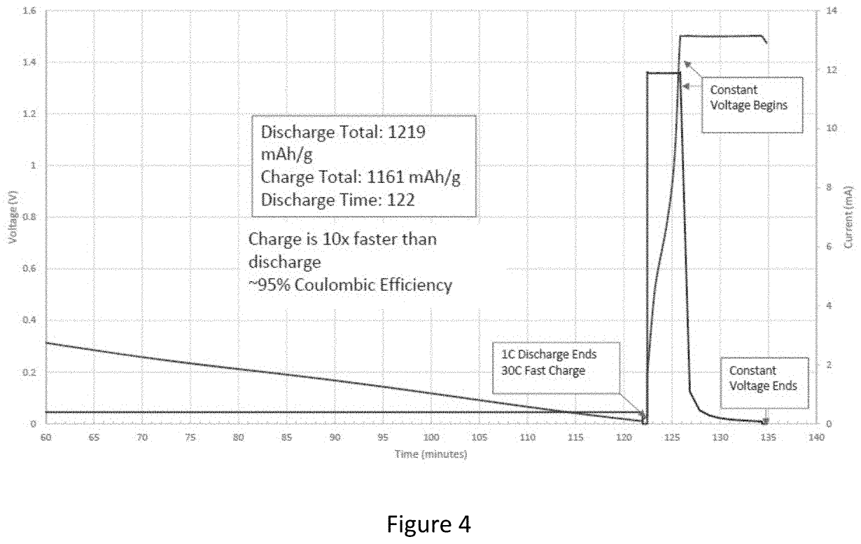

### DETAILED DESCRIPTION OF THE PREFERRED EMBODIMENTS

Batteries provide voltage and electrical current between positive and negative terminals based upon chemical reactions inside the battery. More technically, the chemical reactions occur within cells of the battery, and a given battery can have multiple cells.

The chemical reaction within the battery operates to free electrons to flow externally (e.g., through a load or circuit) from the negative terminal to the positive terminal. The electron flow from negative to positive is functionally equivalent to a “conventional” current flow from the positive terminal to the negative terminal.

The chemical reaction powering the battery may be based on numerous elements and compounds. In some cases, the reaction is reversible. This means that when the reaction is completed, and the cell is partially or completely discharged, it may be restored to its former state (or acceptably close) by restoring the internal chemical compounds to their previous state. This is known as recharging.

Rechargeable cells can be recharged by application of a suitable reverse current and/or voltage. A positive voltage may be applied to the negative terminal which forces electrons to move into the negative terminal instead of out, as occurs during discharge. This corresponds to a conventional current flow into the positive terminal. Internally, the chemical reactions occurring during discharge are reversed. Necessarily, this takes energy, which is “stored” in the battery and accessible by once again operating the battery against a load under normal polarity. Note that there will be some efficiency losses. In other words, the energy that can be taken out of the battery is never exactly what was used to charge it.

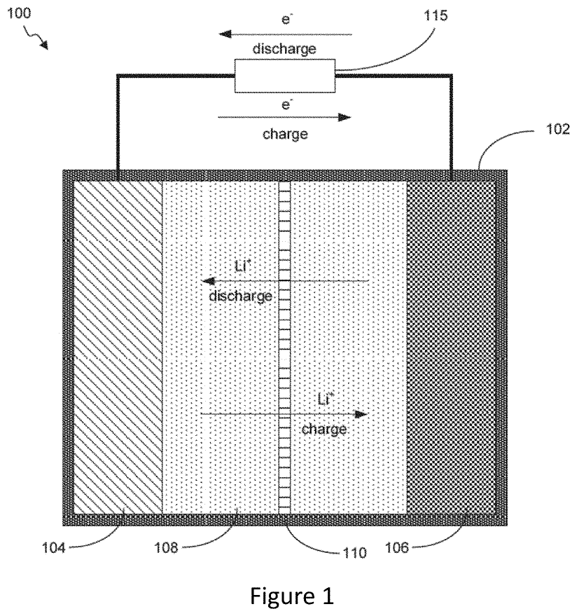

To provide additional specificity, the concepts related to battery construction and operation may be considered with respect to FIG. 1, which illustrates a lithium ion battery cell 100 in a simplified cutaway view. The cell 100 may comprise a casing or container 102. In some embodiments, the casing 102 is a polymer or an alloy. The casing 102 chemically and electrically isolates the contents of the cell 100 from adjacent cells, from contamination, and from damaging or being damaged by other components of the device into which the cell 100 is installed. A complete battery may contain a plurality of cells arranged in a series and/or parallel configuration. The battery may have a further casing or securement mechanism binding the plurality of cells together as is known in the art.

The cell 100 provides a cathode 104 and an anode 106. The contents of the cell 100 undergo a chemical reaction when a conduction path is provided between the cathode 104 and anode 106 that is external to the cell 100. As a result of the chemical reaction, electrons are provided at the anode 106 that flow to the cathode 104 via the load or external circuit. At a basic level, during discharge of the cell 100, the materials comprising the anode 106 are oxidized providing the electrons that flow through the circuit. The materials comprising the cathode 104, as recipient of the electrons given up by the anode 106, are reduced.

Within the cell 100, during discharge, metallic cations move through an electrolyte 108 from the anode 106 to the cathode 104. In the case of a lithium-based battery, the metallic cation may be a lithium cation (Li+). The electrolyte 108 may be a liquid electrolyte such as a lithium salt in an organic solvent (e.g., LiClO₄ in ethylene carbonate). Other lithium-based electrolyte/solvent combinations may be used as are known in the art. In some cases, the electrolyte 108 may be a solid electrolyte such as a lithium salt in a polyethylene oxide. Optionally, the electrolyte may comprise a polymer electrolyte. Example electrolytes include those described in U.S. Patent Application Publication 2017/0069931, which is hereby incorporated by reference.

A separator 110 may be employed to prevent contact between the electrodes 104, 106. The separator 110 may be a porous layer of material that is permeable to the lithium ions and the electrolyte 108 but not otherwise electrically conductive so as to prevent internal shorting of the cell 100. As is known in the art, the separator 110 may comprise glass fibers or may comprise a polymer, possibly with a semi-crystalline structure. Additional components, such as current collectors, may also be included in the cell 100, but are not shown in FIG. 1.

Together the anode 106, cathode 104, electrolyte 108, and separator 110 form the completed cell 100. Since the separator 110 is porous, the electrolyte 108 may flow into, or be contained by, the separator 110. Under normal operating conditions, the porosity of the separator 110 allows for ion (Li+) to flow between the electrodes 104, 106 via the electrolyte 108. As is known in the art, a separator 110 can be constructed so as to melt and close the internal pore structure to shut down the cell in the event of exposure to excess heat or a runaway exothermic reaction.

Most lithium-based cells are so-called secondary batteries. They can be discharged and recharged many times before the chemical or structural integrity of the cell falls below acceptable limits. Cells and batteries, however, can be either primary (e.g., single use) or secondary batteries (possibly used for multiple charge/discharge cycles). Further, a cell may be deployed as a high capacity single-use cell, followed by use as a somewhat generally lower capacity secondary cell.

In the case of the cell 100 being a secondary cell (or part of a secondary battery), it should be understood that the cell 100 may be recharged either alone or as a component of a completed system wherein multiple cells are recharged simultaneously (and possibly in the same parallel or series circuit).

A reverse voltage is applied to the cell 100 in order to effect charging. It should be understood that various schemes for effective recharging of lithium batteries can be employed. Constant current, variable current, constant voltage, variable voltage, partial duty cycles, etc., may be employed. During charging of cell 100, element 115 represents a voltage source that is applied between cathode 104 and anode 106 to provide electrons from cathode 104 to anode 106 and allow chemical reactions to take place. Lithium ions are shuttled from cathode 104 to the anode 106 through electrolyte 108 and separator 110. The reverse process occurs during discharge, where element 115 represents a load on the battery. A load typically has some electrical resistance through which the electrons coming from the cell 100 are moved. In discharge, electrons move from the anode 106 to the cathode 104 through the load 115. Lithium ions move from the anode 106 to the cathode 104 through the electrolyte and separator 110 as the cell 100 discharges.

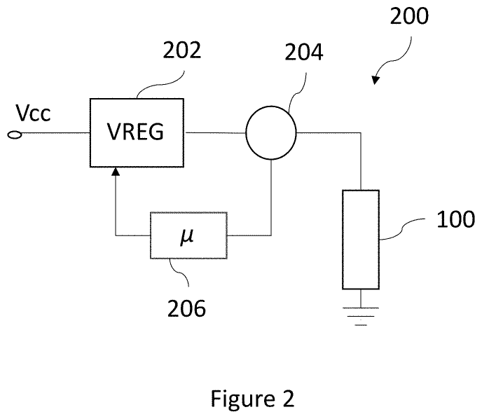

FIG. 2 is a simplified schematic of a battery charging circuit 200. Those of skill in the art will know additional details and auxiliary circuitry necessary to complete a specific charging device for a specific application. The present disclosure is not intended to be limited to specific circuit diagrams and device layout (unless required by the claims). A voltage regulator 202 accepts and inputs voltage Vcc that may be adapted and needed to provide an appropriate charging voltage. It should be understood that an AC/DC transformer and/or an appropriate step-down transformer and associated components may be used to create a suitable Vcc starting with household AC current or similar. The charging voltage output from the voltage regulator 202 taking Vcc as input may vary as described herein.

The cell 100 (possibly as a component of a completed battery) may be connected to the charger 200 so as to receive the output voltage from the voltage regulator 202. The cell 100 may be charged by various stages of constant current and constant voltage. A current sensor 204 may be provided in series with the cell 100 in order for a microcontroller 206 to sense the current flowing into the cell 100. The sensed current may be used as input to a microcontroller 206 to be used as input to provide further control signals to the voltage regulator 202 (e.g., to control output voltage from the voltage regulator 202).

In some embodiments, chargers, according to the present disclosure, are deployed in conjunction with lithium-based batteries containing an acidified metal oxide material as described in U.S. Pat. No. 9,786,910, hereby incorporated by reference. The materials described in this patent may be incorporated into the cell electrodes (e.g., anode and/or cathode). Cells based upon the materials disclosed in this patent have full charge open circuit voltages from about 2 volts to about 4 volts. In some embodiments, these cells operate initially at about 1.5 volts. The voltage diminishes as the cell discharges. Battery chemistry can be complex and practical applications and recharging procedures may be dependent upon battery chemistry. However, systems and methods of the present disclosure are applicable to more traditional battery chemistry (in addition to acidified metal oxide chemistries). In other embodiments of the present disclosure, a system comprises all or a part of a battery charger implemented as described herein, and operating on a battery, batteries, battery cell, and/or battery cells constructed in accordance with WO2018191303, which is hereby incorporated by reference.

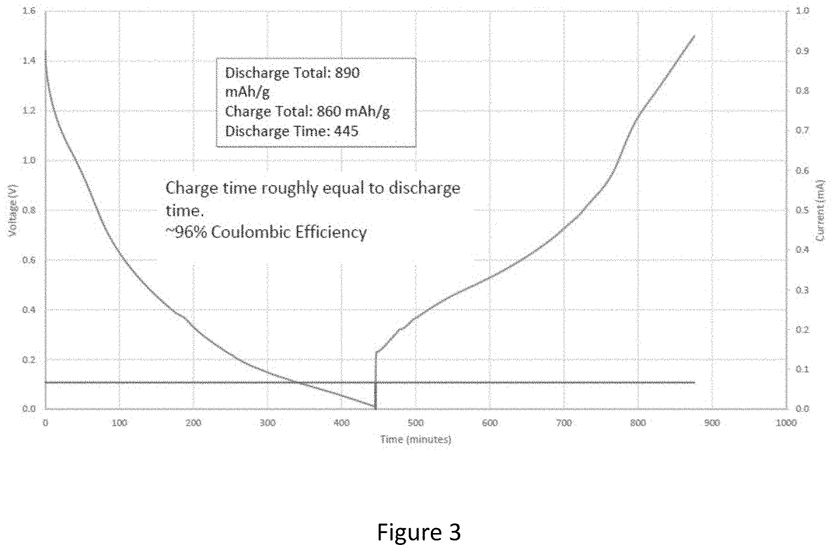

A battery was constructed according to U.S. Pat. No. 9,786,910 as a button cell battery. A charger having a logical function according to FIG. 2 was utilized to demonstrate a baseline discharge/recharge cycle for the battery. This cycle is shown in FIG. 3. It can be seen that the charge and discharge times are roughly equal. The battery was discharged to approximately 0.01V at a rate of 1 C. Constant current was then used (1 C or 0.6 Amps per gram of active material) until the battery charge returned to approximately 1.5 V. This cycle (which was the 9^{th} total for the battery in question) results in approximately 96% Coulombic efficiency.

A fast charge program was developed as follows. From an initial voltage of 1.5V the battery was discharged at a rate of 1 C (at 0.6 Amps per gram of active material) as above. The battery was then charged at a 30 C constant current until the cell reached 1.5 V. This was followed by a constant voltage charge phase until current dropped below a predetermined threshold. In some cases, the threshold was C/5.

Referring now to FIG. 3, an example of the above-described fast charge is shown. A button cell (constructed as above, and on its 9th cycle) was discharged at a rate of 1C until 0.01V was reached. The discharge took approximately 1,222 minutes. The battery was then charged under constant current equivalent to 30 C (in this case, approximately 12 mA). The constant current phase ran until voltage of the battery was measured at approximately 1.5 V. Following this a constant voltage hold was applied until the rate of charge fell below C/5.

This fast charge program resulted in a charge time of only 12 minutes and resulted in a Coulombic efficiency of approximately 95%. Using a modified fast charge program, the Coulombic efficiency can be further improved. The cutoff current in the constant voltage phase can be changed to C/10 at the expense of longer charge times.

Higher C rates may also be used in the constant current phase, but the inventors have found that rates above 30C show diminishing returns with respect to total charge time.

The fast charge program can also be operated at higher voltages. The inventors have operated from 2.6 V to 0.01 V with similar efficiencies and no immediately observable degradation in the cells. Additionally, the fast charge program has been shown to operate on cells having traditional construction, as well as those constructed according to U.S. Pat. No. 9,786,910 incorporating acidic metal oxide active materials.

Further fast charge programs have been developed according to the present disclosure. In one embodiment, the constant current portion of the fast charge program is 10 C. In other embodiments, the constant current portion of the fast charge program ranges from 10 C to 30 C. In some embodiments, the constant current portion of the fast charge program deviates from the 0.6 Amps per gram of active material described above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not to be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A system comprising:
at least one high performance battery cell incorporating an acidified metal oxide in at least one electrode thereof; and
a battery charger implementing a charge cycle of constant current until a predetermined voltage threshold is obtained on the cell followed by a constant voltage until a predetermined minimum charge rate is reached.

2. The system of claim 3, wherein the constant current is equivalent to 30 C.

3. The system of claim 3, wherein the minimum charge rate is C/5.

4. A system comprising:
at least one battery cell; and
a battery charger implementing a charge cycle of constant current until a predetermined voltage threshold is obtained on the cell followed by a constant voltage until a predetermined minimum charge rate is reached.

5. The system of claim 3, wherein the constant current is equivalent to 30 C.

6. The system of claim 3, wherein the minimum charge rate is C/5.

7. A method of charging a battery cell comprising:
first, applying a constant current to the battery cell until a predetermined voltage is reached on the battery cell; and
second, applying a constant voltage to the battery cell.

8. The method of claim 7, wherein the constant voltage is applied to the battery cell until a predetermined charge rate is observed.

9. The method of claim 8, wherein the constant current is equivalent to at least 10 C.

10. The method of claim 9, wherein the constant current is equivalent to 30 C.

11. The method of claim 8, wherein the predetermined charge rate is C/5 or less.

12. The method of claim 8, wherein the predetermined charge rate is C/10 or less.
